(19) United States
(12) Patent Application Publication
(10) Pub. No.: US 2001/0003184 A1
(43) Pub. Date: Jun. 7, 2001

(54) Methods and articles of manufacture for interfacing, advertising and navigating with internet television

(76) Inventors: Jamison K. Ching, San Diego, CA (US); Thomas P. Romero, San Diego, CA (US)

Correspondence Address: DAVID R PRESTON & ASSOCIATES, 11404 SORRENTO VALLEY ROAD, SUITE 104, SAN DIEGO, CA, 92121, US

(21) Appl. No.: 09/735,208

(22) Filed: Dec. 12, 2000

Related U.S. Application Data
(63) Continuation-in-part of application No. 09/565,990, filed on May 6, 2000.
(63) Continuation-in-part of application No. PCT/US00/40353, filed on Jul. 11, 2000.
(63) Continuation-in-part of application No. 09/456,632, filed on Dec. 8, 1999.
Application No. 09/456,632 is a continuation-in-part of application No. 09/354,979, filed on Jul. 16, 1999.

(51) Int. Cl. G06F 17/30

(52) U.S. Cl. 707/4; 707/1

(57) ABSTRACT

The present invention recognizes that Internet users who utilize Internet televison devices to interface with the Internet do not have the same needs as Internet users who use computers. The present invention addresses the needs of television Internet users to interface with the Internet by providing appropriate interfacing methods, compositions and articles of manufacture. One aspect of the present invention is a word code that includes a series of numerical digits that relates to a word or portion of a word. Another aspect of the present invention is a method of making a word code that includes identifying a word or portion of a word that is an appropriate word code and translating the word or portion of a word into a word code. A further aspect of the present invention is a composition of matter or an article of manufacture that includes at least two word codes. Another aspect of the present invention is a method of searching a database that includes providing a database or word codes, providing a query in the form of a word code and comparing the query to the database. A further aspect of the present invention is a method of retrieving information from a database, including providing a database of word codes, providing a query in the form of a word code, comparing the query to the database to obtain at least one selected word code, obtaining an output that includes at least one selected word code, and translating the selected word code into a selected word. Another aspect of the present invention is a composition that includes at least one selected word code or at least one selected word retrieved using a method of the present invention. A further aspect of the present invention is a numerical keypad that can be used to enter a word code and includes an overlay for a keypad. Another aspect of the present invention is a method of entering alphanumeric text into a data processing unit, including providing a keypad of the present invention and entering a number into the data processing unit using the keypad. A further aspect of the present invention is A ninth aspect of the present invention is a method of linking an Internet site with a video site.

This application is a continuation-in-part of U.S. Ser. No. 09/565,990, filed May 6, 2000 and a continuation-in-part of PCT Application Number PCT/US00/40353, filed Jul. 11, 2000; each of which are continuations-in-part of U.S. Ser. No. 09/456,632 filed Dec. 8, 1999, which is a continuation-in-part of U.S. Ser. No. 09/354,979 filed Jul. 16, 1999, each of which is incorporated herein by reference.

### TECHNICAL FIELD

The present invention relates to the field of Internet television and methods and articles of manufacture that efficiently classify and search locations for use with Internet television hardware and software.

### BACKGROUND

Internet users have traditionally used computers to interface with the Internet. Recently, WebTV and other service providers have allowed Internet access that allows a user to interface with the Internet using a television screen, set-top device and remote control rather than a computer, monitor and keyboard and/or mouse. Many World Wide Web (WWW) locations and methods are not well suited for use with television Internet interface, which results in poor quality Internet interfacing. The present invention provides various methods, compositions and articles of manufacture that are particularly useful for television Internet interfacing.

### BRIEF DESCRIPTION OF THE FIGURES

FIG. 1A depicts a preferred keypad of the present invention in top, front, rear, right and left views.

FIG. 1B depicts a back and perspective view of the keypad of FIG. 1A, where the perspective view does not depict the letters, numbers and symbols set forth in the top view of FIG. 1A, but these letters, numbers and symbols are intended.

FIG. 1C depicts an alternative top view of a keypad of FIG. 1A.

FIG. 1D depicts an alternative top view of a keypad of FIG. 1A.

FIG. 1E depicts an alternative top view of a keypad of FIG. 1A.

FIG. 1F depicts top, bottom, front, back, left, right and perspective views of an overlay of the present invention. The present invention includes alternative overlays that have alternative lettering, symbols or numbers. The perspective view does not depict the lettering and symbols provided on the top view, but these lettering and symbols is intended.

FIG. 2 depicts another preferred keypad of the present invention.

FIG. 3 depicts a schematic diagram of one aspect of the present invention.

FIG. 4 depicts a schematic diagram of one aspect of the present invention.

FIG. 5 depicts a schematic diagram of one aspect of the present invention.

FIG. 6 depicts a p referred output routine of the present invention.

FIG. 7 depicts a preferred output routine of the present invention.

FIG. 8 depicts a preferred output routine of the present invention.

FIG. 9 depicts a schematic of a preferred system of the present invention. In this system, a user enters an alphanumeric word using a keypad (100) of his/her remote control (102) which is transmitted to an Internet TV device (110) as a wordcode numeric string. This wordcode is transmitted via the Internet (120) to a web server (130) which accesses a word database (140), matches the wordcode (144) back to the address (148). If the wordcode (145) is assigned to multiple words (147) in the word database, the server will present these words to the user and then execute the action assigned to the chosen word (149). If the wordcode is not in the word database, the server accesses a dictionary database (150) and displays to the user, possible words (146) which match the wordcode (144). When the user selects his/her desired word (146), the server (130) then uses this information in another web application such as a search engine.

FIG. 10A depicts a description of one preferred method for Internet advertising of TV channels or streaming video.

FIG. 10B depicts a description of one preferred method for Internet advertising of TV channels or streaming video.

FIG. 10C depicts a schematic of one preferred method, system and devices for Internet advertising of TV channels or streaming video that uses an additional communication device, such as a telephone or cellular phone.

FIG. 10D depicts a schematic of one preferred method, system and devices for Internet advertising of TV channels or streaming video.

FIG. 10E depicts an image on a web page that includes an Internet banner served to a user. This FIG. 10E utilizes the system depicted in FIG. 10D.

FIG. 10F depicts the case in FIG. 10D where the user cable/satellite system and corresponding TV channel lineup are not readily determinable from a user's IP address information.

FIG. 10G depicts the use of interstitial advertisement in one aspect of the present invention.

### SUMMARY

The present invention recognizes that Internet users who utilize Internet televison devices to interface with the Internet do not have the same needs as Internet users who use computers. The present invention addresses the needs of television Internet users to interface with the Internet by providing appropriate interfacing methods, compositions and articles of manufacture.

One aspect of the present invention is a word code that includes a series of numerical digits that relates to a word or portion of a word. The word code can be entered using a numerical keypad that relates a number to a number or a letter. The word code can be provided in a variety of formats, such as a machine-readable format.

A second aspect of the present invention is a method of making a word code that includes identifying a word or portion of a word that is an appropriate word code and translating the word or portion of a word into a word code.

A third aspect of the present invention is a composition of matter or an article of manufacture that includes at least two word codes. The word codes can be provided in any format, but are preferably provided in a machine-readable format, such as a magnetic medium. The composition can have a two or more word codes arranged in a database, such as in an appropriate order, such as numerical or sequential from when entered into a database.

A fourth aspect of the present invention is a method of searching a database that includes providing a database of word codes, providing a query in the form of a word code and comparing the query to the database.

A fifth aspect of the present invention is a method of retrieving information from a database, including providing a database of word codes, providing a query in the form of a word code, comparing the query to the database to obtain at least one selected word code, obtaining an output that includes at least one selected word code, and translating the selected word code into a selected word. The selected word can be ranked in the instance that a word code is associated with more than one word. The selected word code or selected word can be displayed, preferably using a user-friendly format. The selected word code or selected word can also relate to additional information or link to additional information, such as an Internet search engine, a URL, a TVRL or a TV channel location.

A sixth aspect of the present invention is a composition that includes at least one selected word code or at least one selected word retrieved using a method of the present invention. The selected word code(s) or selected words can be provided in any format, preferably in a machine-readable format, and can also be provided in a database.

A seventh aspect of the present invention is a numerical keypad that can be used to enter a word code. The numerical keypad can have any appropriate configuration, including but not limited to a remote control unit, a keyboard or a touchscreen. The numerical keypad preferably correlates one or more letters with one or more numbers, preferably more than one letter corresponding to one number. The present invention also includes an overlay for an existing keypad.

An eighth aspect of the present invention is a method of entering alphanumeric text into a data processing unit, including providing a keypad of the present invention and entering a number into the data processing unit using the keypad.

A ninth aspect of the present invention is a method of linking an Internet site, such as a URL, with a video feed such as TV location or television station.

### DETAILED DESCRIPTION OF THE INVENTION

### Definitions

Unless defined otherwise, all technical and scientific terms used herein have the same meaning as commonly understood by one of ordinary skill in the art to which this invention belongs as exemplified by a variety of technical dictionaries or sources, such as, for example Muller, Desktop Encyclopedia of Telecommunications (1999). Conventional methods are used for the procedures, such as those provided in the art and various general references. Where a term is provided in the singular, the inventors also contemplate the plural of that term.

A “word” refers to a string of letters, numbers and/or symbols that have a meaning, including a linguistic meaning or a legal meaning (such as a trademark). A portion of a word is any portion, contiguous or noncontiguous, of a word. A word can be in any language, and any alphabet, including a phonetic alphabet as is used in certain languages, such as Japanese.

A “word code” refers to a string of numbers that corresponds via a concordance to a word or a portion of a word. Preferably, a word code is made of the number 1 to 9, inclusive, with the zero being reserved as a special character. A “TV Hypercode” is another term for a word code.

A “special character” refers to a number other than 1 to 9, inclusive, or a symbol, such as a space, a star, a pound sign, a @ sign, a & sign and a period or comma that provides information in addition to the information provided by a word code.

“Translation” refers to changing a word to a word code, or a word code to a word, using a concordance or program.

A “machine readable format” refers to a format that is useable by a machine, such as a central processing unit or a processing unit. The machine readable format can be any appropriate format, such as paper, magnetic medium or polymers such as cycloolifin polymers or copolymers. Data is provided on a machine-readable format in an appropriate manner. For example, data on a paper machine-readable format can be provided as marks or holes on the paper, or a combination thereof.

A “database” refers to an arrangement of data, preferably on at least one machine-readable format on at least one machine at least one location. The data can be arranged in any appropriate way using, for example, database management software as is known in the art or as commercially available. The data can be arranged, for example, numerically, alphabetically or in the order in which it was entered into the database. A database can be maintained and searched using software commercially available and as known in the art.

A “query” refers to data that is used to compare with a database to identify members of the database that correspond at least in part to the query. The comparing can be performed using software as it is known in the art or commercially available. The comparing results in no or one or more “hits,” which refers to identified members of a database that correspond at least in part to the query. “Corresponds at least in part” means that the match between the query and the member of the database need not be exact, but have a degree of similarity that indicates that the query and the identified member of the database are similar in some regard. Such comparing can be performed using software known in the art and as commercially available.

“Ranking” refers to organizing an output such that the members of an output (should there be a plurality of members of an output) are arranged in an appropriate way, such as the percentage of matching between a query and a member of a database. For example, an identified member of a database 1111 would have a higher ranking than another member of a database 1234 when the query was 1111 or 1115, the former being an exact match. Also, ranking refers to ranking of words associated with the same word key, such as books and cooks.

“Displaying” refers to selecting and arranging the identified members of a database in a manner that is useful to a user, where a user can be any user, including a human or a machine. If a user is a human, then the display is preferably in a format, language and arrangement that is useful to a user.

A “user friendly format” refers to a format that is appropriate for a particular user. For example, different displays may be appropriate for human users of different cultures, differing languages or differing geographic locations. If the user is a machine, then the display should be in an appropriate format, such as in code, such as binary or hex.

“Linking” refers to the process of identifying an Internet link location or TV channel location, such as a URL, or TVRL. Linking can include connecting with the identified Internet link location or TV channel location.

A “URL” or Uniform Resource Locator, refers to a unique pointer to data on the World Wide Web that can contain information about protocol (such as HTTP), the Internet Server Hostename, the directory and the file name of data.

A “HTTP” or Hypertext Transfer Protocol, refers to an Internet communications protocol usually used with a URL to communicate between a web browser and a web server.

A “TVRL” or Television Resource Locator, refers to a pointer to a TV channel that can be used within a web page or web browser to send commands to an Internet television device. TVRLs have also been referred to as TV HTML extensions, Broadcast HTML or Broadcast URLs.

An “advertisement” refers to a display that refers to a good or service. On the Internet, such displays can be, for example, banners, text or graphics, or a combination thereof.

A “keypad” refers to a device, such as a remote control unit, keyboard, or touchscreen, that includes letters, numbers or symbols. The keypad can operate via pressure sensitive pads, mechanically engaged keys, heat sensitive pads, or thin-pad type structures. Preferably, the keypad is an “alphanumeric keypad” that includes letters that are directly associated with one or more numbers. By directly associated, a number and a letter are printed in proximity to each other. For example, a number and a letter can be printed on the same key on a keypad, such as on a telephone keypad, or the letter and number can be arranged so that one is on the key and one is not on the key but their orientation and proximity to each other and to the key indicate that the key is associated with the number and letter, or the number and the letter can be arranged so that neither is on the key but their proximity to each other and to the key indicate that the key is associated with the number and letter.

“Data” refers to information in any form, such as letters, symbols, numbers or combination thereof. Preferably, data refers to numbers or numbers in combination with letters, but that need not be the case.

### Introduction

The present invention recognizes that Internet users who utilize Internet televison devices to interface with the Internet do not have the same needs as Internet users who use computers. The present invention addresses the needs of television Internet users to interface with the Internet by providing appropriate interfacing methods, compositions and articles of manufacture.

As a non-limiting introduction to the breadth of the present invention, the present invention includes several general and useful aspects, including:

1) a word code that includes a series of digits that relates to a word or portion of a word;

2) a method of making a word code that includes identifying a word or portion of a word that is an appropriate word code and translating the word or portion of a word into a word code;

3) a composition of matter or an article of manufacture that includes at least two word codes;

4) a method of searching a database that includes providing a database of word codes, providing a query in the form of a word code and comparing the query to the database;

5) a method of retrieving information from a database, including providing a database of word codes, providing a query in the form of a word code, comparing the query to the database to obtain at least one selected word code, obtaining an output that includes at least one selected word code, and translating the selected word code into a selected word;

6) a composition that includes at least one selected word code or at least one selected word retrieved using a method of the present invention;

7) a keypad that can be used to enter a word code and an overlay for a keypad. The keypad can have any appropriate configuration, including but not limited to a remote control unit, a keyboard or a touchscreen;

8) a method of entering alphanumeric text into a data processing unit, including providing a keypad of the present invention and entering a number into the data processing unit using the keypad; and

9) a method of linking an Internet site, such as a URL, with a video feed, such as a TV location or television station.

These aspects of the invention, as well as others described herein, can be achieved by using the methods, articles of manufacture, compounds and compositions of matter described herein. To gain a full appreciation of the scope of the present invention, it will be further recognized that various aspects of the present invention can be combined to make desirable embodiments of the invention.

A. A WORD CODE

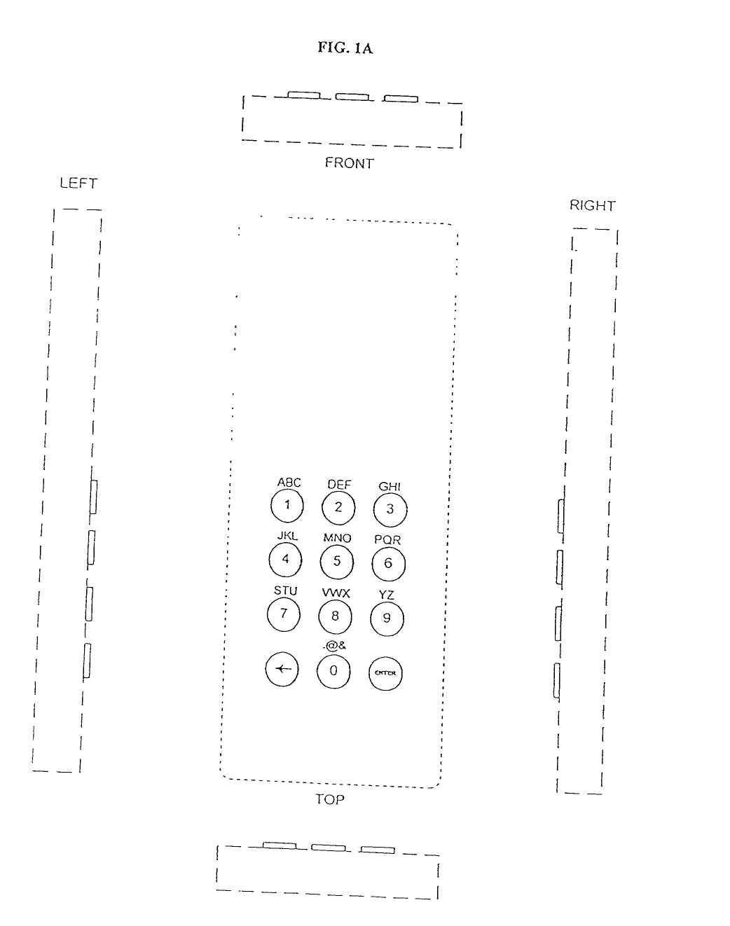

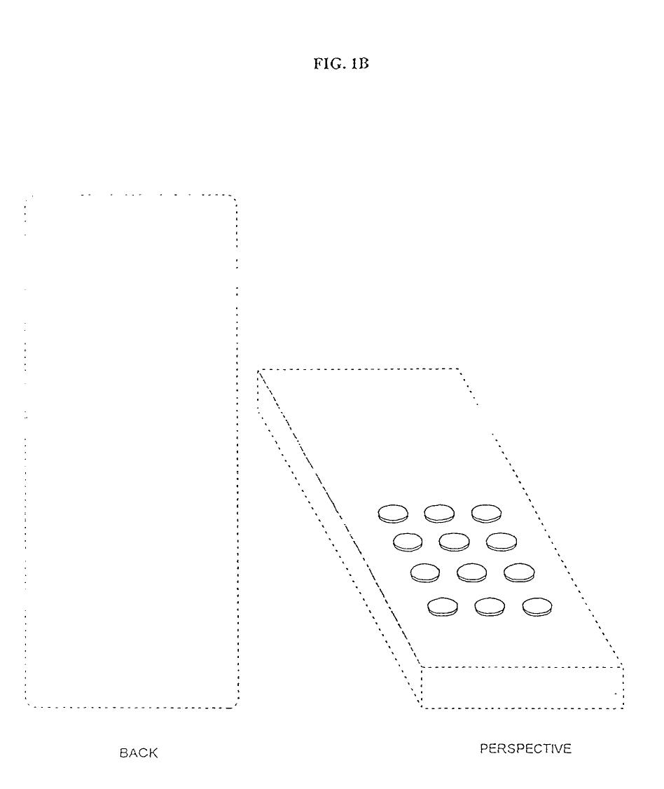

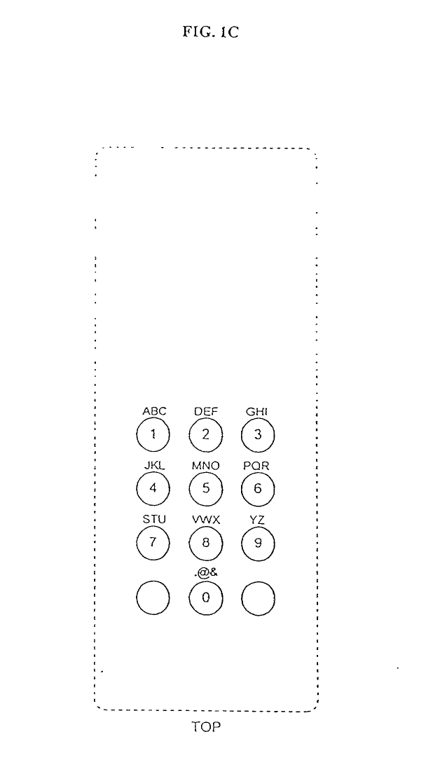

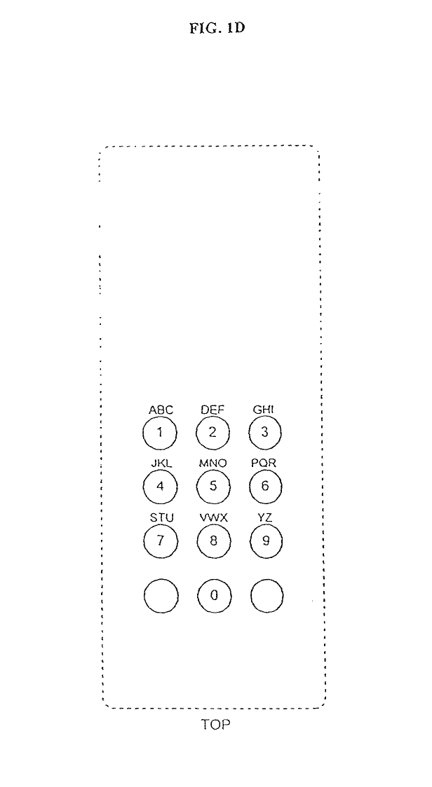

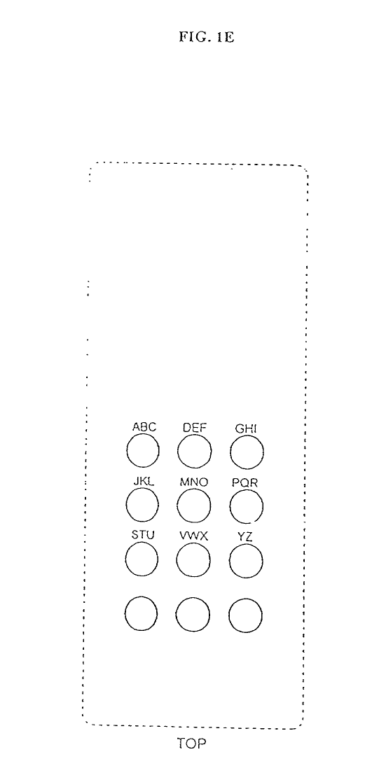

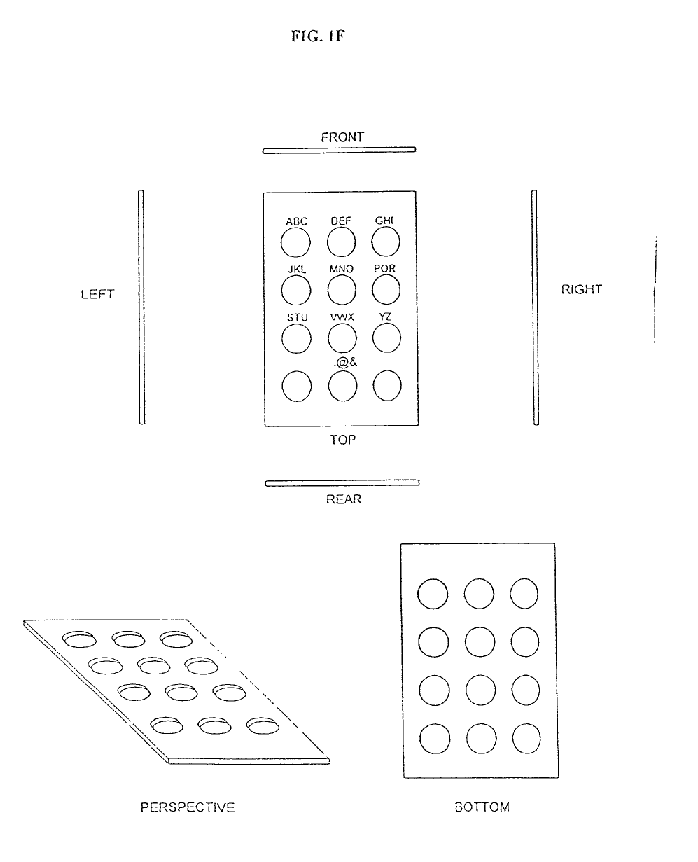

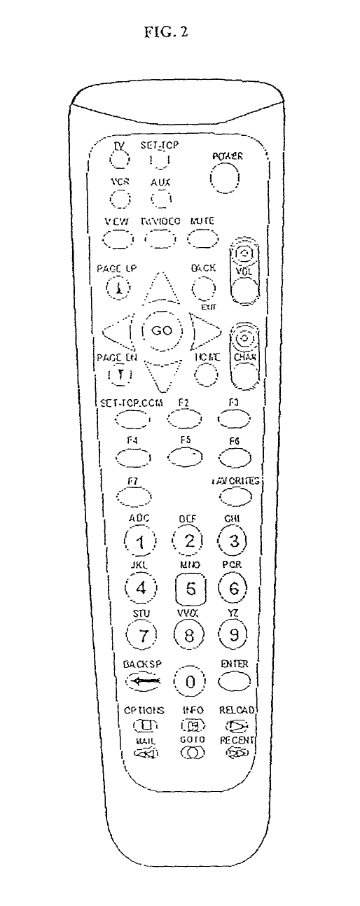

The present invention includes a word code that includes a series of numerical digits that relates to a word or portion of a word. The word code can be provided in a variety of formats, including a machine-readable format. The word code can be formed by entering a word or a portion of a word into a central processing unit using a concordance, which can include a concordance device such as a keypad, including a keyboard, remote control device or touchscreen. One preferred example of a concordance includes the following and is set forth in FIG. 1 and FIG. 2:

the digit 1 refers to the letters A, B and C and the number 1;

the digit 2 refers to the letters D, E and F and the number 2;

the digit 3 refers to the letters G, H and I and the number 3;

the digit 4 refers to the letters J, K, and L and the number 4;

the digit 5 refers to the letters M, N and O and the number 5;

the digit 6 refers to the letters P, Q and R and the number 6;

the digit 7 refers to the letters S, T and U and the number 7;

the digit 8 refers to the letters V, W and X and the number 8; and

the digit 9 refers to the letters Y and Z and the number 9; optionally

the digit 0 refers to a special character, such as a space, *, #, ., @, &, wildcard and the number 0.

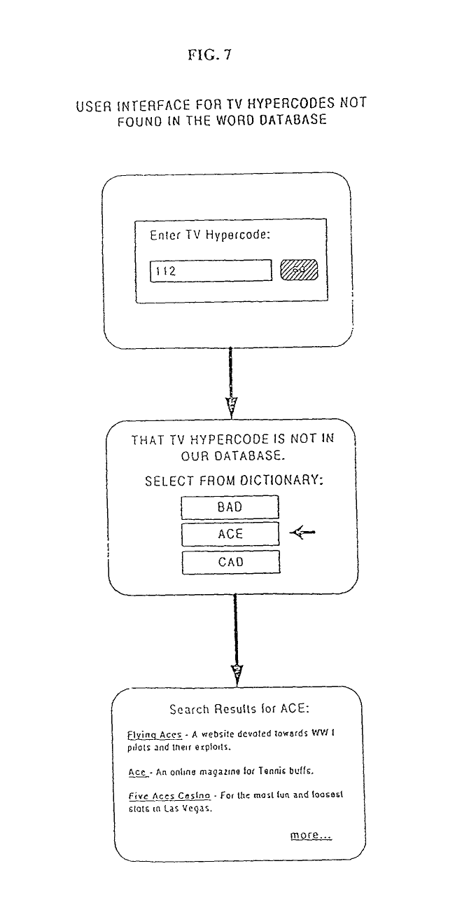

Appropriate concordance result in relatively few multiple listings of word codes due to the particular language or alphabet being used (FIG. 7). As the length of a word code increases, the number of multiple listing decreases, but the chosen concordance has an impact on the phenomenon of multiple listings. Preferred concordance can be identified using the following methods.

The present invention also includes a method to optimally assign letters, characters, or symbols to a keypad. This method is particularly useful when there are more characters than keys and the interface must be designed to accept as many unique character or symbol sequences while avoiding duplication of key sequences. By avoiding duplication of key sequences, a user may represent a large random (non-predefined) set of words (sequences of characters) without the requirement for a full keyboard of characters. This example uses the English alphabet as the character set, and a base 10 numeric keypad as the mapped keypad, but other alphabets, symbols, characters and numbers can be used, such as are used in a variety of languages.

This method utilizes an estimation of the usage frequencies of the character set within the specified language or word set. In Table I, the usage frequencies are shown for the various characters in an English dictionary. These frequencies are shown as a percentage or (number of instances of a character in a text/total number of characters in the text). These frequencies may vary between texts, but are generally similar when a large sample is taken from a dictionary or large body of text.

In addition, in most cases there exists an pre-defined order of characters within a character set; such as in the case of the English alphabet it is ABCEDEFGHIJKLMNOPQRSTUVWXYZ. Preferably, the order of the characteristic is maintained on the keypad to allow the user to easily find the character he/she is seeking. This method preferably uses an inherent maintained order, but may also be used if the character set has no predefined order.

After estimating character frequencies and determining the character order, the number of keys on the keypad to be used is determined. For example, the 26-character English alphabet can be mapped to a 9-key keypad and a 10-key keypad. The method used is to determine the optimum frequency or probability that each key may be pressed. In the instance of a 9-key keypad, the optimum frequency is 1/9 or 0.11111. In the instance of the 1 0-key keypad, the optimum frequency is 1/10 or 0.10000. By grouping characters to match these optimum frequencies as closely as possible, the method avoids duplication of key sequences by minimizing the probability that one key will be used more than another.

In Table II, two versions of 9-digit key mappings are shown. In the first version, key 1 is assigned to the characters ABC with a use frequency of 0.112 (0.079+0.003+0.030 from Table I). This grouping by itself may be more optimal than version 2 that assigns characters ABCD with a use frequency of 0.156, since it is closer to the optimal use frequency determined by the 9-digit keypad 1/9 or 0.111. However, since the grouping of characters affects the other groupings downstream, the overall optimal assignment may be not known until all assignments are completed. After grouping the first set of characters, the next set of characters are also grouped to approach the optimum frequency of 0.111. In Table II, version 2 is more optimally assigned to keypad digit 2 than version 1 and only includes one letter. These groupings continue until all characters are assigned to all keys. The user may find that he or she may have to rearrange previous groupings because they result in too little or too much use frequency in the later key assignments. Such optimization can be routinely made.

The determination of overall optimal assignment can be measured by comparing standard deviations from the mean (optimal) use frequency. In the case of the two 9-digit key assignments shown below, version 2 may be considered “optimal” or “preferable” because its standard deviation (SDEV) is 0.026 versus 0.068 for version 1. Standard deviation measures the “variability” of the data from the optimal mean. Another measure is the MEDIAN or middle value in the data, where half of all the keys will receive more usage and the other half less usage. Although it's important that the MEDIAN be close to the MEAN, it is of secondary importance to maintaining a low standard deviation.

In Table II, version 2 is more optimized for use than version 1 on a 9-key keypad. Version 1 may receive heavy use on keys 2, 5 and 7 since their frequencies are high, which may result in more duplicated key sequences for different character strings. However, version 1 is more user-friendly than version 2 since it equally distributes the characters amongst each key making it easier for users to pick out characters. A further example for a 10-key keypad is shown in version 3 in Table II.

This method may be applied to any character set mapped onto a keypad, including Spanish characters and Japanese phonetics (katakana or hiragana). Computer simulations using this method will be able to evaluate all possible groupings for optimal mapping, but may not take into account the human interface factors that must also be considered.

TABLE I
Usage Frequencies of English Alphabet Letters

| Character | A | B | C | D | E | F | G | H | I | J | K | L | M |
|---|---|---|---|---|---|---|---|---|---|---|---|---|---|
| Frequency | 0.073 | 0.009 | 0.030 | 0.044 | 0.130 | 0.028 | 0.016 | 0.035 | 0.074 | 0.002 | 0.003 | 0.035 | 0.025 |
| Character | N | O | P | Q | R | S | T | U | V | W | X | Y | Z |
| Frequency | 0.078 | 0.074 | 0.027 | 0.003 | 0.077 | 0.063 | 0.093 | 0.027 | 0.013 | 0.016 | 0.005 | 0.019 | 0.001 |

TABLE II
Examples of Key Mappings
Version 1

| Number | 1 | 2 | 3 | 4 | 5 | 6 | 7 | 8 | 9 | 0 |
|---|---|---|---|---|---|---|---|---|---|---|
| Frequency | 0.112 | 0.202 | 0.13 | 0.04 | 0.177 | 0.107 | 0.183 | 0.034 | 0.02 | 0.111 |
| | Mean | Median | SDEV | ADEV | | | | | | |
| | 0.112 | 0.068 | 0.0541 | | | | | | | |

Version 2

| Letters | ABCD | E | FGH | IJKL | MN | OPQ | RS | T | UVWXYZ |
|---|---|---|---|---|---|---|---|---|---|
| Frequency | 0.156 | 0.13 | 0.08 | 0.114 | 0.103 | 0.104 | 0.140 | 0.093 | 0.081 |
| | Mean | Median | SDEV | ADEV | | | | | |
| | 0.111 | 0.104 | 0.026 | 0.0212 | | | | | |

Version 3

| Letters | AB | CD | E | FGH | IJKL | MN | OPQ | RS | T |
|---|---|---|---|---|---|---|---|---|---|
| Frequency | 0.082 | 0.074 | 0.13 | 0.079 | 0.114 | 0.103 | 0.104 | 0.14 | 0.093 |
| | Mean | Median | SDEV | ADEV | | | | | |
| | 0.100 | 0.098 | 0.023 | 0.0182 | | | | | |

The concordance can be provided in the form of a device, such as a keypad, remote control or touchscreen (FIG. 1A to FIG. 1E and FIG. 2). For example, the letters and numbers can be provided in a keypad, such as on a standard television remote control, such that the concordance of letters to numbers is established. The device can then be used to enter a word code into a processing unit or Internet interfacing device. A word code can be of any appropriate length, but is preferably between about 3 digits and about 20 digits in length, and more preferably between about 5 digits and about 10 digits.

The concordance can also be provided in the form of an overlay for an existing keypad, such as depicted in FIG. 1F. Such overlays can be made of any appropriate material, but are preferably made of clear, opaque or colored plastics, including ridged or flexible plastics. The overlay can be adhered to a keypad using adhesives, mechanical structures such as tongue and groove engagement, or by plastics that reversibly adhere to surfaces. Such overlays can be made using appropriate methods, such as printing on a plastic sheet and cutting the plastic sheet before or after printing in order to provide the outline of an existing keypad. The size and shape of the openings of the overlay and the overall shape and configuration of the overlay is related to the keypad that the overlay is being designed from.

B. A METHOD OF MAKING A WORD CODE

The present invention also includes a method of making a word code that includes identifying a word or portion of a word that is an appropriate word code and translating the word or portion of a word into a word code.

Words or portions of words can are appropriate for word codes are words themselves, including trademarks and advertising misspelling, such as, for example, “booksrus” or “books r us.” The words or portion of words are preferably the length of a word code, such as between about 3 digits and about 20 digits. The selected word or portion of a word is then translated into a word code. This translation can take place using a concordance or using a device of the present invention. The translation can also take place using a database structure, where, for example, a database of identified words or portions of words is compiled into a database of words and/or portion of words. The members of the database of words and/or portion of words are then translated into a database or word codes using a selected concordance and an appropriate conversion program, such as are readily available, such as in the art of cryptography.

C. A COMPOSITION OF MATTER INCLUDING WORD CODES

The present invention also includes a composition of matter or an article of manufacture that includes at least two word codes. The at least two word codes are preferably provided in a machine-readable format and can be optionally provided in the format of a database. The members of the database can be arranged in any appropriate manner, such as numerical order or in the order in which they were entered into the database. Appropriate database creation and maintenance programs are available in the art and many are commercially available.

D. A METHOD OF SEARCHING A DATABASE

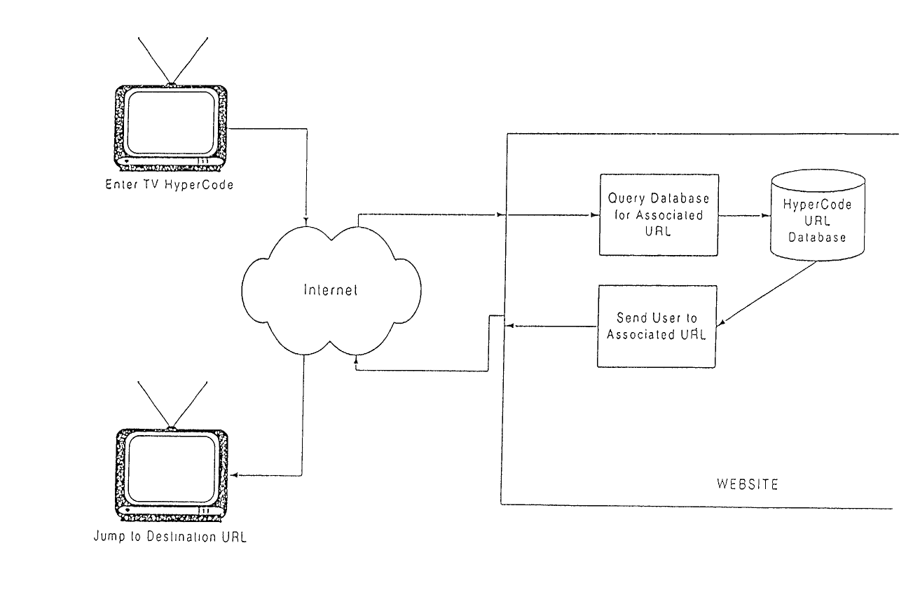

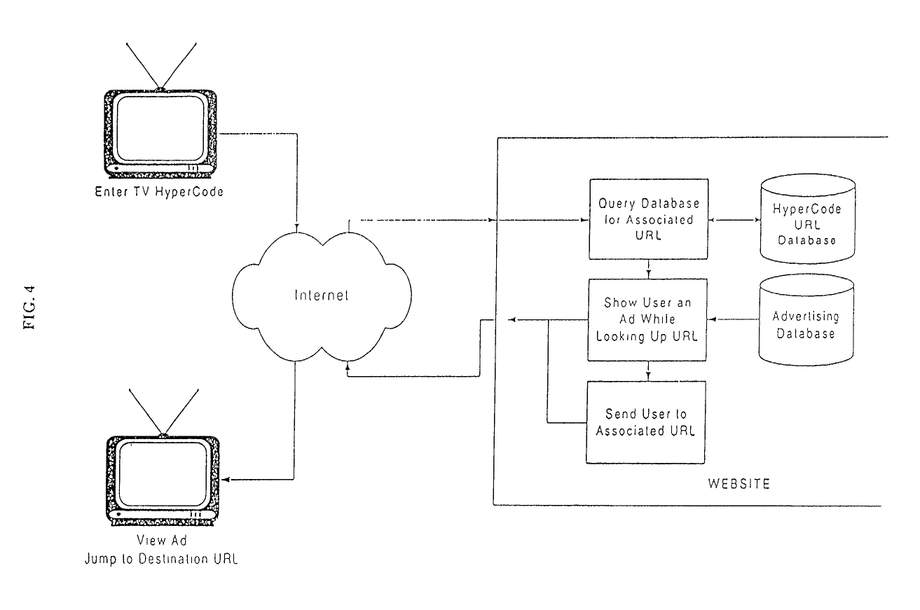

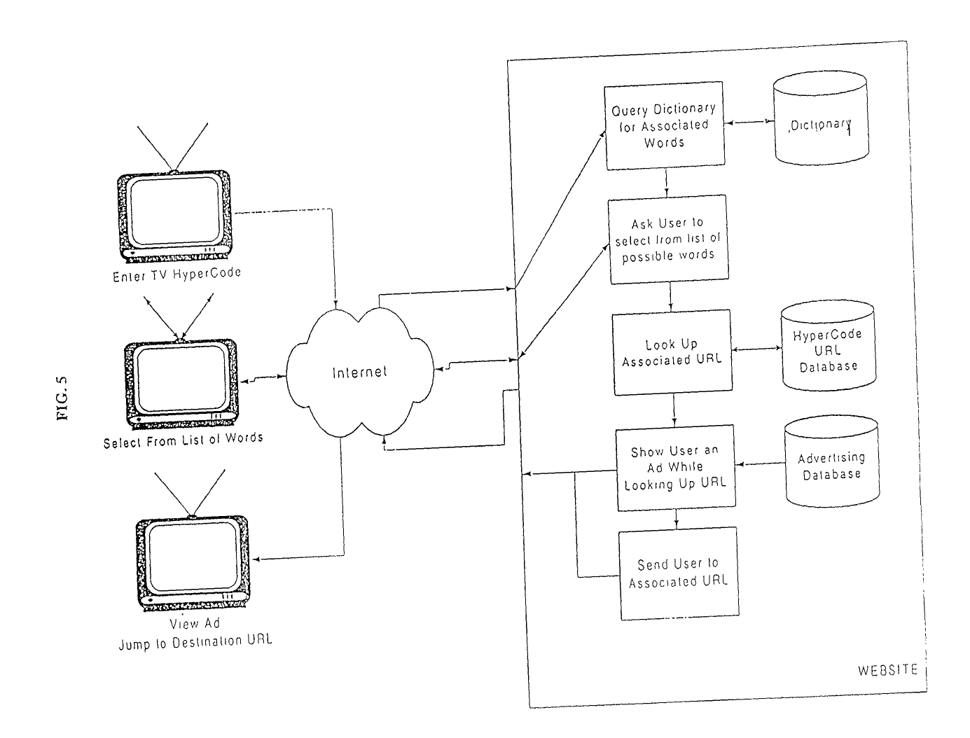

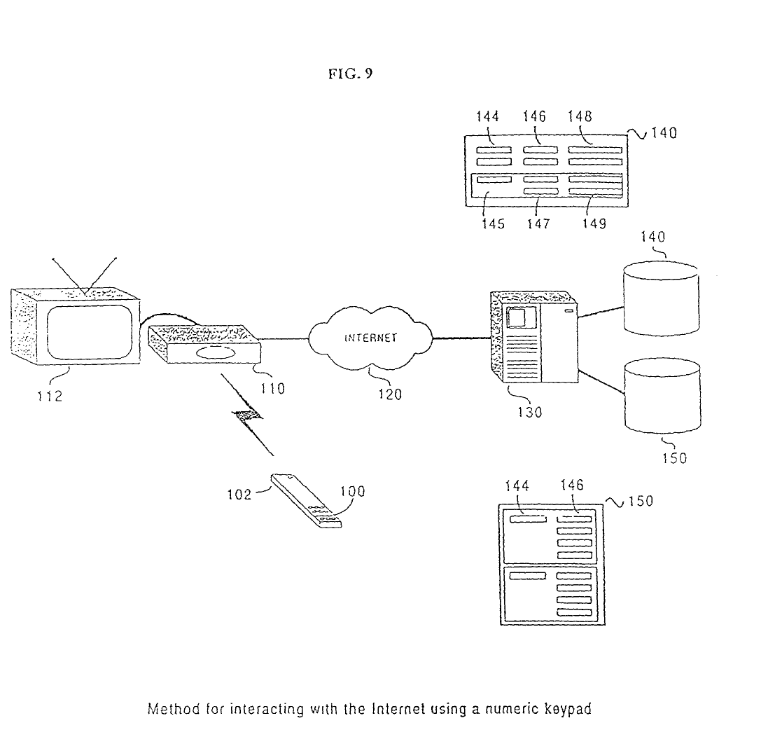

The present invention also includes a method of searching a database that includes providing a database or word codes, providing a query in the form of a word code and comparing the query to the database. Flow diagrams of this method are provided in FIG. 3, FIG. 4, FIG. 5, and FIG. 9.

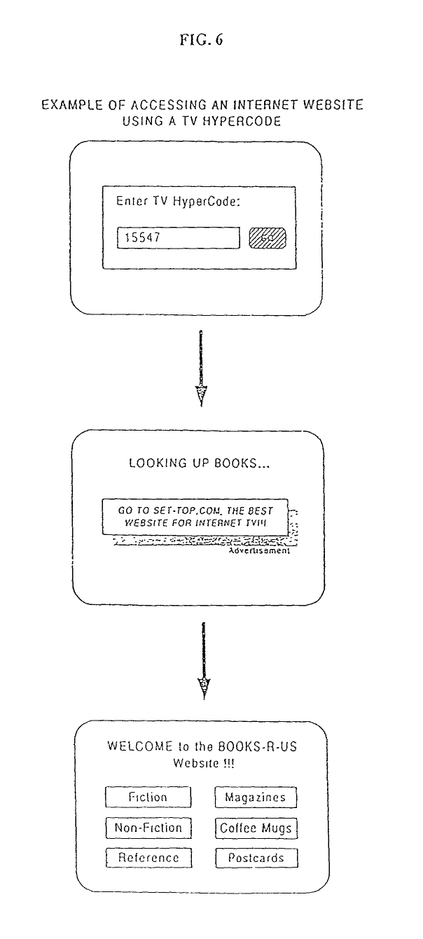

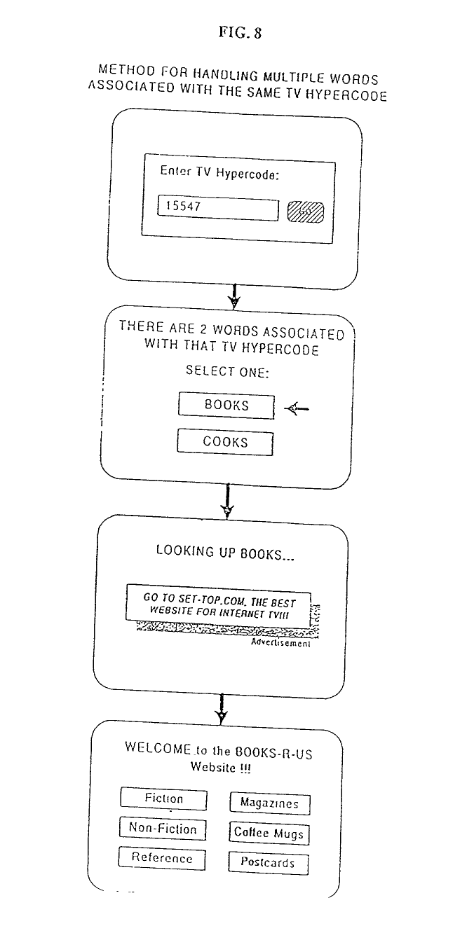

In a preferred aspect of the invention, a database of word codes is provided at one or more sites. A query is provided by a user in the form of a word code or TV hypercode (FIG. 6, FIG. 7 and FIG. 8), preferably using a device of the present invention, such as a keypad. The wordcode is then compared with the database or word codes using appropriate search routines such as they are known in the art and often commercially available. The comparing of the word code with the database of word codes can be of differing stringencies, such that, for example, only exact matches are designated as “hits” or where a certain degree of mismatching is permitted for a “hit” to be indicated. Such comparing can be performed using established methods and software, such as are commercially available. Preferred comparing routines are in the arts of database searching and cryptography.

E. A METHOD OF RETRIEVING INFORMATION

The present invention also includes a method of retrieving information from a database, including providing a database of word codes, providing a query in the form of a word code, comparing the query to the database to obtain at least one selected word code, obtaining an output that includes at least one selected word code, and translating the selected word code into a selected word.

After the steps described in Section D are performed, the identified hit or hits are provided as at least one selected word code. At this point in time the word code is in a numerical configuration. Preferably, the word code is translated to the word from which the word code was derived so that any outputs resulting from the search and translation are in a format that is user-friendly for a human operator.

Optionally, if more than one word code or word is identified as a hit, then the word codes or words are ranked as to the appropriateness of the hit. This aspect of the present invention is preferable if the comparing step identifies matches between the query and the database of word codes that are not exact. The ranking can be performed using database searching and displaying routines as they are known in the art and are often commercially available, such as those used by the National Institutes of Health in its Grateful Med and BLAST database searching and comparing routines. This ranking can take place before or after the translation or word code to word.

Identified words or word codes can be displayed prior to or after translation and prior to or after ranking. The display is preferably in a user-friendly format relative to the intended user. For example, if the user is a human, then the interface would preferably include words rather than word codes in a user interface that optionally uses graphics. If the user is a machine, then the display would preferably in a numerical configuration such as a word code or a word code in hex or binary language or other appropriate machine-readable format.

The display can also relate the word or word code to additional information. For example, a display can show a word or a word code. The word code or word can be selected by a user using a user interface, such as a “point and click” device. The selected word code or word is then activated to link to additional information at an Internet search engine, a URL, a TVRL or a TV channel location. During the time that the relating and linking takes place, or additional time or less time as a programer would choose, and advertisement can be displayed. The advertisement can take a variety of forms, such as banners, graphics, text, combinations thereof, and the like. A summary of these processes is provided in FIG. 3 to FIG. 9, in particular by FIG. 9.

F. A COMPOSITION THAT INCLUDES SELECTED WORD CODE(S)

The present invention also includes a composition that includes at least one selected word code or at least one selected word retrieved using a method of the present invention. The word(s) or word code(s) retrieved using the present invention can be provided in the form of a composition, such as a machine-readable format, such as a disk, or a machine, such as a processing unit or memory device (permanent or temporary), including a disk drive, such as a hard drive or RAM. The word(s) or word code(s) can be compiled into a database, which in turn can be provided on a machine-readable format and is considered part of the present invention. The database can be made using database programs available in the art and the members of the database can be stored in any acceptable order, such as in numerical order, alphabetical order or in the order in which the members of the database were entered. The members of the database can be provided in an acceptable format, such as alphanumeric, numeric or code such as binary or hex.

G. A KEYPAD

The present invention also includes a keypad that can be used to enter a word code. The keypad can have any appropriate configuration, including but not limited to a remote control unit, a keyboard or a touchscreen. The invention includes an overlay for a keypad, particularly a remote control unit as depicted in FIG. 1 and FIG. 2, that provides a concordance between numbers and letters on the keypad. Examples of preferred keypads of the present invention are provided in FIG. 1 and FIG. 2.

The keypad can have keys arranged in any appropriate configuration, such as in a tabular form as in FIG. 1, or can be arranged in alternative configurations as are known in the art, such as in the designs of keypads for electronic devices such as televisions, stereos or DVDs and Internet devices.

The concordance of numbers to letter presented on a keypad can be any of the present invention. A preferred concordance is:

the digit 1 corresponds to the letters A, B and C and the number 1;

the digit 2 corresponds to the letters D, E and F and the number 2;

the digit 3 corresponds to the letters G, H and I and the number 3;

the digit 4 corresponds to the letters J, K, and L and the number 4;

the digit 5 corresponds to the letters M, N and O and the number 5;

the digit 6 corresponds to the letters P, Q and R and the number 6;

the digit 7 corresponds to the letters S, T and U and the number 7;

the digit 8 corresponds to the letters V, W and X and the number 8; and

the digit 9 corresponds to the letters Y and Z and the number 9; optionally

the digit 0 corresponds to a space, #, *, ., @, &, a wildcard or the number 0.

The keypad of the present invention need not display both numbers and letters. The keypad can optionally display only letters, wherein the corresponding numbers are implicit or not implicit from their location on the keypad and the spacial relationship to each other.

H. A METHOD OF ENTERING DATA INTO A DATA PROCESSING UNIT

The present invention also includes a method of entering data into a data processing unit, including providing a keypad of the present invention and entering a number into the data processing unit using the keypad. This process can be performed by a person or a machine.

I. A METHOD OF LINKING AN INTERNET SITE WITH A TV LOCATION

The present invention also includes a method of linking an Internet site with a video feed, such as a TV location. In operation, this method includes providing an Internet user that utilizes a television set as an interface with the Internet, preferably using an appropriate interface, such as a Set-Top device, with an option to link to video feed, such as a television location, such as a television station. The option preferably is a button which the user can select by clicking on the button. When the user elects to choose the option by, for example, clicking on a button, the user is taken to the video feed. Software and hardware to support the link between the Internet and a video feed are available in the art (U.S. Pat. No. 5,774,664 to Hidary et al., issued Jun. 30, 1998; U.S. Pat. No. 5,778,181 to Hidary et al., issued Jul. 7, 1998; U.S. Pat. 5,961,603 to Kunkel et al., issued Oct. 5, 1999; WO 97/13368 to Schein et al., published Apr. 10, 1997 and WO 97/33434 to Weilacher, published Sep. 12, 1997). Preferably, the user is utilizing wordcode technology as described herein. The option to link to a video feed is preferably presented in interstitial time, either real-time or purposely introduced, while a user is linking between Internet locations.

The method of the present invention can include providing an Internet user an option to link to a video feed, and linking the user to a video feed upon selection of said option by the user. The user is preferably a human, but the user can also be an interface device, such as a central processing unit. During operation, the option to link to a video feed is preferably displayed on a television set, wherein the television set interfaces with the Internet using appropriate hardware and software, such as a Set-Top device. Other interfacing devices can be used, such as they are known in the art or later developed. The option can take any form, but preferably comprises a button, banner, static banner, animated banner or dynamic video clip that the user can select. More preferably, the option takes the form of an advertisement.

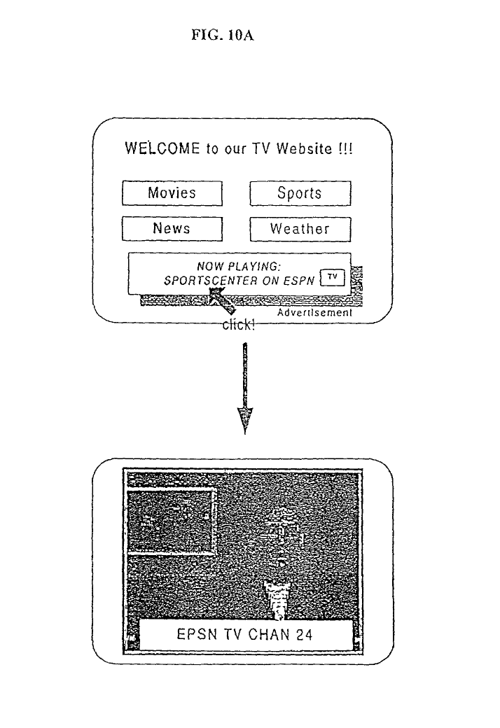

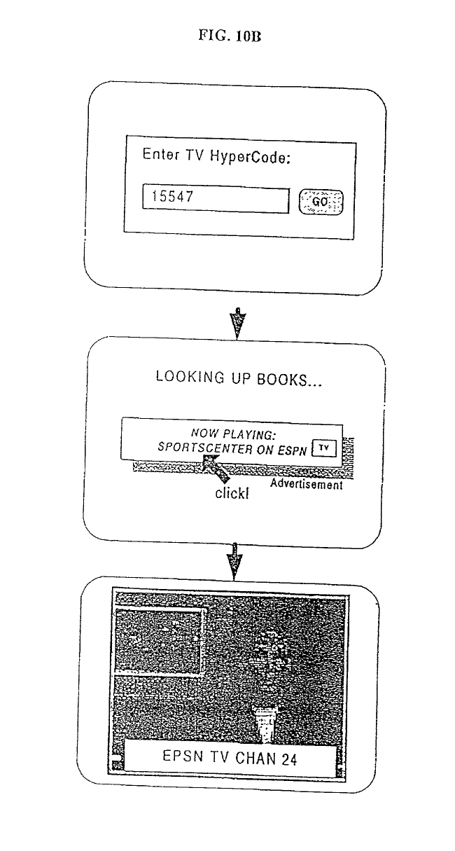

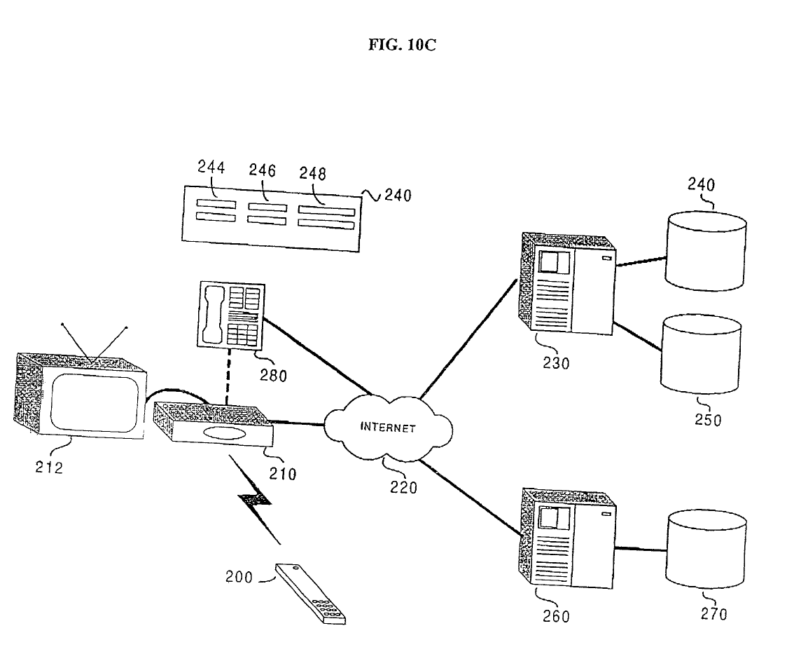

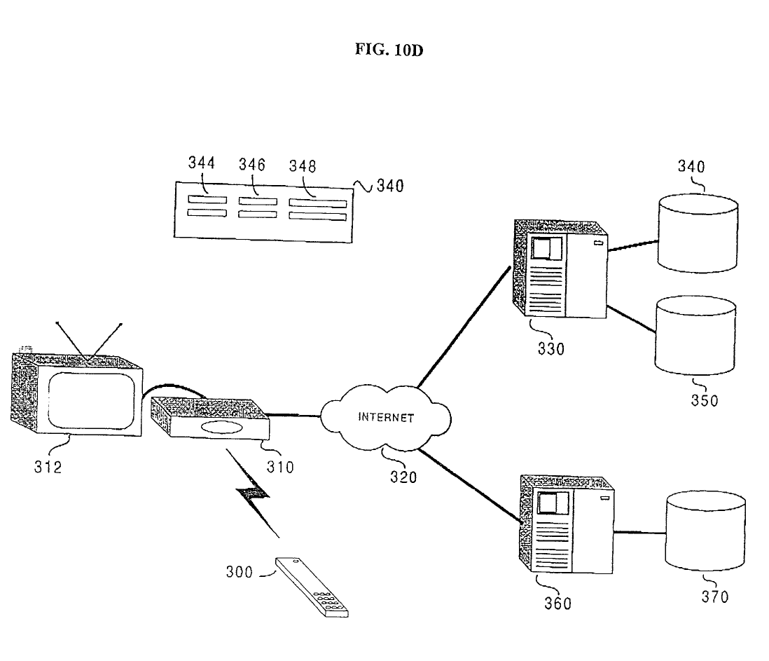

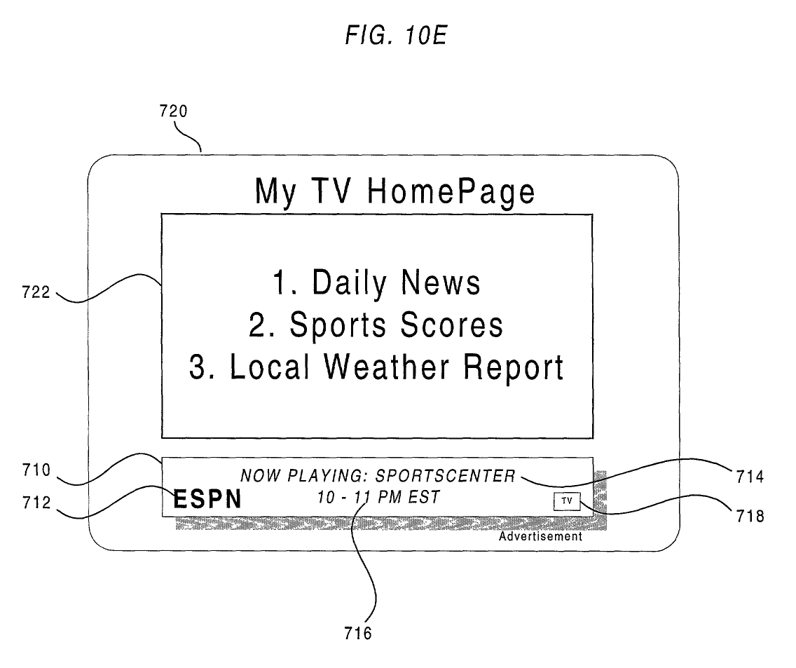

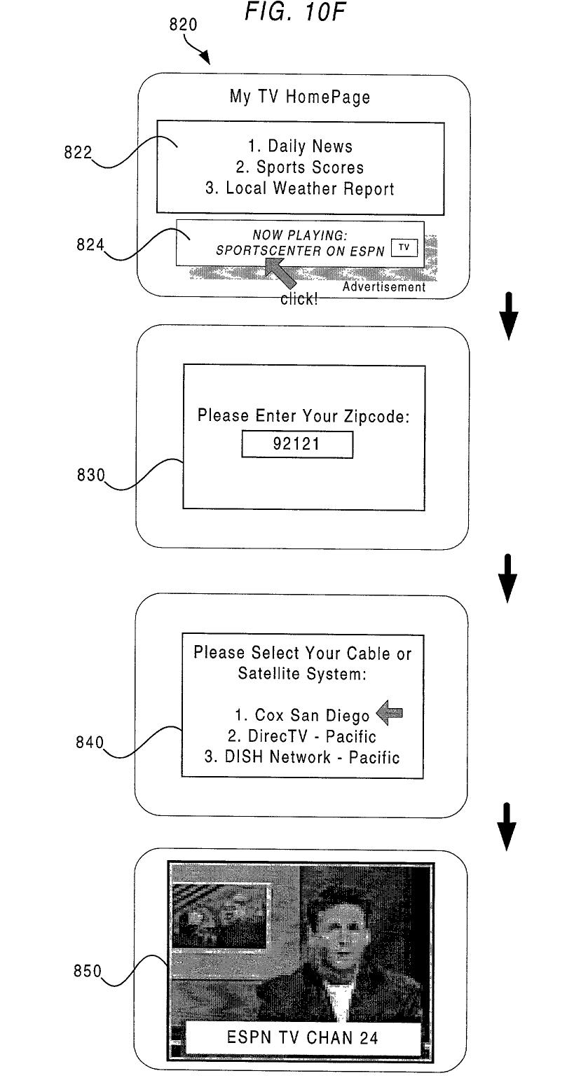

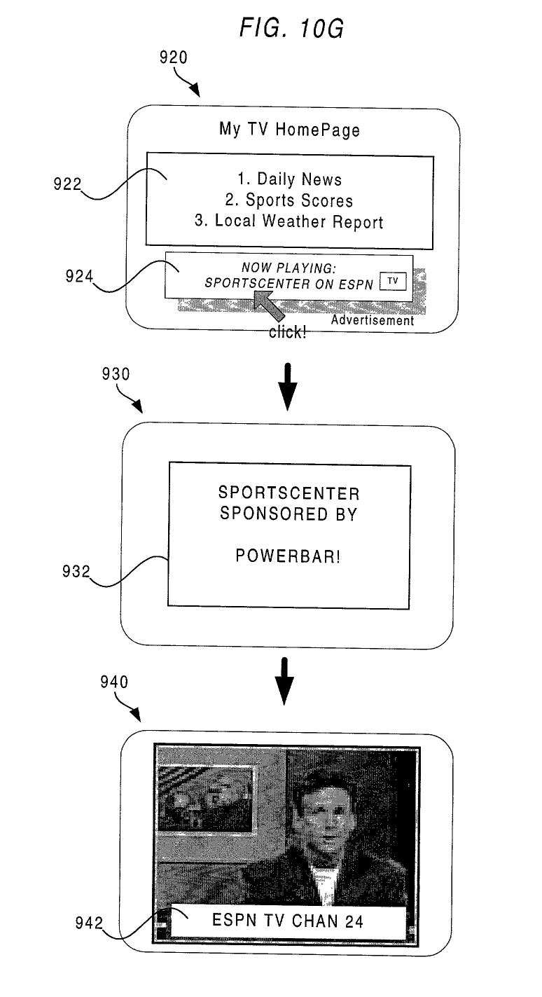

Preferred aspects of the present invention are provided in FIG. 10A, FIG. 10B, FIG. 10C and FIG. 10D. In FIG. 10A, a user is shown an Internet web page on a Television screen. At the web page, a user is provided an option, such as an advertisement, for a video link such as a TV channel, TV show or streaming video that may be playing at that time, in the past or in the future. The advertisement is preferably labeled so that it can be identified as a Click-For-TV advertisement as opposed to a standard banner that “links” to a static web site. The user selects, such as by “clicking” on, the advertisement and a command is sent to the user's Internet interface device, such as a Set-Top Box or television, which displays and tunes to the video link. The advertisement can take any form, such as a static banner, animated banner or dynamic video clip.

In FIG. 10B, a user is shown an Internet we page on a Television screen. The user links to another web page, preferably using word codes of the present invention. As the destination web page is being loaded, the user is shown an interstitial option, such as an advertisement, for a video link, such as a TV channel, TV show or streaming video that may be planing at that time or in the past or future. The option is labeled so that it can be identified as a Click-For-TV advertisement as opposed to a standard banner advertisement that “links” to a static web site. The user selects or “clicks” on the advertisement and a command is sent to the Internet interface, such as a Set-Top Box or TV that links and displays and tunes to the TV channel or streaming video. The option, such as an advertisement can be in the form of a static banner, animated banner or dynamic video clip.

In FIG. 10C, a user accesses an Internet website using an Internet TV device (210) or other Internet access device such as a telephone (280) which may be connected through an Internet TV device, directly to the Internet or both. The website contains an advertisement which is transmitted to the users screen from an advertising server (230) through the Internet (220) or similar network. This advertisement contains information promoting a TV channel, a telephone ordering service, or other service such as pizza delivery. The advertisement may be stored on the server (230) or dynamically created from a scheduling database (240) and template graphic (250). The scheduling database may include information such as TV channel information (244), telephone number (246), or current news or weather (248), as well as other information which may be included in the advertisement. The scheduling database may be used to display ads promoting events playing currently and in the near future, particularly events that can be viewed on a television or similar device (212). The advertising server (230) may also be intelligent and serve advertisements based on user information such as zip code, time zone, Internet browser type, or other demographic or user device configuration information. If the user selects or “clicks” on the Internet advertisement, a command is sent to the Internet TV device (210), telephone (280), or similar access device which causes the device to perform a specific function such as change to a specific TV channel, dial a telephone number, or tune to a radio station or the like. The advertisement may promote a pizza delivery service where when the user clicks on the advertisement, the number for the closest pizzaria is dialed for the user. It may also be used to advertise TV shows, where when the user clicks o the advertisement, the TV is tuned to the desired TV channel and show. This can be accomplished by the advertising server (230) through embedding a command or code when the advertisement is served which is activated by the user selection to perform an appropriate activity. It can also be accomplished by directing the user to a website (260) or webpage which contains the command or code which is transmitted back to the Internet access device to follow. The corresponding website may access a database (270) containing TV channel information, telephone numbers, or similar commands that the Internet device can execute.

In FIG. 10D, a user accesses an Internet website using an Internet TV device (310), an input device such as a remote control (300), and viewed on a TV (312). The website contains an advertisement which is transmitted to the users screen from an advertising server (330) through the Internet (320) or similar network. This advertisement contains information promoting a TV channel, TV show, or streaming video. The advertisement may be stored on the server (330) or dynamically created from a TV program listing database (340) and template graphic (350). The TV program listing database may include information such as TV channel name (344), TV show name (346), and TV show time (348), as well as other information relating to programming information which may be included in the advertisement. The TV program listing database may be used to display ads promoting TV shows playing currently and in the near future. The advertising server (330) may also be intelligent and serve advertisements based on user information such as cable system, zip code, time zone, Internet browser type, or other demographic or user device configuration information. If the user selects or “clicks” on the Internet advertisement, a command is followed by the Internet TV device (310) to display the corresponding TV channel or TV show to the user and viewed on the TV (312). This can be accomplished by the advertising server (330) through embedding a command or code when the advertisement is served which is activated by the user selection to display the video or video stream. It can also be accomplished by directing the user to a website (360) or webpage which contains the command code which is transmitted back to the Internet TV device (310) to follow. The corresponding website may access a database (370) containing TV channel call signs, TV channel numbers, streaming video web addresses, or similar video location information.

### DESCRIPTION OF A SPECIFIC EMBODIMENT OF THE INVENTION

The present invention provides systems and methods for advertising a video feed such as a TV channel using Internet-based advertising systems, and linking viewers to the video feed as a result of their interaction with the advertisement. In one preferred aspect of the present invention, the advertising methods of the present invention may be implemented using devices or systems that have access to both the Internet and television, such as a television connected to a set-top box, an Internet-enabled televisions, a PCTV combination unit, or a personal computer equipped with a TV tuner board.

In one aspect of the present invention, such as depicted in FIG. 10D, the user views the Internet (320) via a set-top box (310) connected to a television display (312). The user can be viewing web pages that are served through the public Internet (320) or through private or quasi-private network servers that are not generally available to the public such as “walled gardens.” Embedded within these web pages are advertisements such as banner advertisements that are displayed within web pages. Advertising services providers such as AdForce, DoubleClick or 24/7 Media can be used as a source of such advertisements. These advertisements can be generally or specifically targeted such that the advertisement can be dependent on various user criteria and demographics such as, but not limited to, the time of day, the website topic, Internet Protocol (IP) address (such as that of the user), Internet Service Provider (ISP) (such as that of the user) such as WebTV or AOLTV, satellite or cable system (such as that of the user) such as DISH Network or Cox Cable) or the user's personal profile information. The user can be an authorized user or an unauthorized user. The advertisements can be of various sizes and forms, including 468×60 pixel banners, smaller button ads, animated banners, banners with embedded video, text only banners, text links and the like as they are used for Internet advertising.

In one aspect of the present invention depicted in FIG. 10E, a user is served an Internet advertisement (710) embedded in a web page (722) on the television based on the user's ISP and/or browser type. Browsers can be of any type that can be used for viewing TV, such as Microsoft TV, WebTV. Liberate, Navio, Worldgate or Open TV. Such targeting of advertisements tends to increase the probability that the user is viewing the Internet using a television-based access device such as a set-top box. The user can be shown an advertisement (710) such as a banner that a particular TV show (714) is currently, previously or will be shown on a television system, such as but not limited to the television system linked to the user. Preferably, this advertisement has been scheduled to display shortly prior to and during the broadcast of the TV show, but that need not be the case. A scheduling mechanism of an advertising service provider can be used to facilitate this process, when such advertising service providers are used. In one aspect of the present invention, the advertisement can show the name of the TV channel (712), the name of the TV show (714), the start and end times of the broadcast (716) and an identifying icon (718) to signify to the user that the advertisement will link the user to a TV show if appropriately selected or activated.

When a user selects or activates an advertisement, the user's browser is instructed by the advertising service provider to obtain appropriate information, such as instructions to link to a TV location. This information can be obtained from a third-party web server. In one aspect of the present invention, a third-party web server sends back a web page that contains the appropriate instructions for directing the user's set-top box to tune to an appropriate TV channel. For example, in the case of a WebTV user that has selected an advertisement for CNN, the web server will return a web page instructing the WebTV set-top box to tune to the TV channel where CNN is currently playing using a redirect command to TV:CNN in the HTML header of the returned web page. Alternatively, in the case of a Liberate (Navio) browser, the web server may return a web page with CNN displayed as a televison background of the web page. The different codes to control different set-top boxes may be stored in an online database. Various TV-compatible web browsers can have other various mechanisms for commanding the set-tope box to tune to the appropriate channel that will be familiar to those skilled in the art.

In another preferred aspect of the present invention, looking toward FIG. 10D, advertisements such as banner advertisements are created dynamically by a graphics server (330) connected to a TV programs listing database (340), as opposed to creating static ads before scheduling them to run at determined times. Using this method, the advertising service provided (such as but not limited to AdForce, DoubleClick or the like) can access a specified advertisement graphics file that changes the TV show it promotes based on what is currently playing of that identified TV channel. By way of example, at 1:00 P.M. a banner advertisement for CNN may promote “TalkBack Live” while at 2:00 P.M. the advertisement is changed to promote “The World Today,” such as in accordance with CNN scheduling. Various available software packages for the web, including MacroMedia Generator, can be used to dynamically embed database information within graphics.

In another preferred aspect of the present invention, such as depicted in FIG. 10F, where the user's cable/satellite system and corresponding TV channel lineup cannot be readily determined from the IP address information, browser detection or other non-intrusive methods, devices or means, the user can be queried for a user's geographical identifier, such as a zip code, partial zip code, phone number, area code, exchange or combinations thereof (830) and optionally additional information such as cable/satellite system information (840) after selecting or engaging the advertisement, such as by clicking. By identifying their cable/satellite system, the user's particular channel lineup information can be accessed and the user's set-top box can be commanded to change to a particular channel number or channel identifier or ID (850). The user's cable/satellite system information can then be saved as an Internet cookie or in an advertising database so that the user is not required to enter the information every time. This information can be used to target additional advertisements that will appear to the user-based on the availability of specific TV channels and shows on the user's designated cable or satellite network.

In yet another preferred embodiment of the present invention, such as depicted in FIG. 10G, the user activates an advertisement (924) and is shown an interstitial advertisement (932) before being tuned to the advertised TV channel (942). The interstitial advertisement (932) can take the form of text, static graphic, animated graphic or video related to the selected or related TV show, channel or network. The interstitial advertisement can promote a consumer product or sponsor. Additionally, the interstitial advertisement can itself be selectable for more information and link to a website or to be tuned to another TV channel.

All publications, including patent documents, world wide web sites, book chapters, books and scientific articles, referred to in this application and set forth in the bibliography are incorporated by reference in their entirety for all purposes to the same extent as if each individual publication were individually incorporated by reference.

All headings are for the convenience of the reader and should not be used to limit the meaning of the text that follows the heading, unless so specified.

What is claimed is:

1. A word code that comprises a string of digits that relates to a word or portion of a word.

2. The word code of claim 1 provided in a machine-readable format.

3. The word code of claim 1, wherein:
a) the digit 1 refers to the letters A, B and C and the number 1;
b) the digit 2 refers to the letters D, E and F and the number 2;
c) the digit 3 refers to the letters O, H and I and the number 3;
d) the digit 4 refers to the letters J, K, and L and the number 4;
e) the digit 5 refers to the letters M, N and O and the number 5;
f) the digit 6 refers to the letters P, Q and R and the number 6;
g) the digit 7 refers to the letters S, T and U and the number 7;
h) the digit 8 refers to the letters V, W and X and the number 8; and
i) the digit 9 refers to the letters Y and Z and the number 9.

4. The word code of claim 1, wherein the digit 0 refers to a special character.

5. The word code of claim 1, wherein said string of digits is between about 3 digits and about 20 digits.

6. T he word code of claim 1, wherein said string of digits is between about 5 digits and about 10 digits.

7. A method of making a word code, comprising:
a) identifying a word or portion of a word that is an appropriate word code; and
b) translating said word or portion of a word into a word code.

8. An article of manufacture, comprising: two or more word codes.

9. The article of manufacture of claim 8, wherein said word codes are provided in a machine-readable format.

10. The article of manufacture of claim 8, wherein said two or more word codes is a database of word codes.

11. A method of searching a database, comprising:
a) providing a database of word codes;
b) providing a query in the form of a word code; and
c) comparing said query to said database.

12. A method of retrieving information from a database, comprising:
a) providing a database of word codes;
b) providing a query in the form of a word code;
c) comparing said query to said database to obtain at least one selected word code;
d) obtaining an output comprising at least one selected word code;
e) translating said at least one selected word code to at least one word.

13. The method of claim 12, further comprising ranking said selected word codes or said words if more that one word code or word is obtained.

14. The method of claim 12, further comprising displaying said at least one selected word.

15. The method of claim 12, wherein said displaying is in a user-friendly format.

16. The method of claim 12, further comprising relating said at least one selected word code or at least one word to additional information at an Internet search engine, a URL, a TVRL or a TV channel location.

17. The method of claim 16, wherein said related includes linking said word code or said word to said Internet search engine, URL, TVRL or TV channel location.

18. The method of claim 17, wherein an advertisement is displayed prior to said linking.

19. The method of claim 12, wherein said output comprises possible words when said comparing results in no exact match between said query and said database.

20. The method of claim 19, wherein a user selects a word from said output.

21. The method of claim 20, wherein said user is linked to an Internet search engine.

22. An article of manufacture, comprising: at least one word code or at least one word retrieved using the method of claim 12.

23. The article of manufacture of claim 17, wherein said at least one word code or at least one word is in a machine readable format.

24. A keypad, comprising an array of numbers and letters, wherein:
a) the digit 1 corresponds to the letters A, B and C and the number 1;
b) the digit 2 corresponds to the letters D, E and F and the number 2;
c) the digit 3 corresponds to the letters G, H and I and the number 3;
d) the digit 4 corresponds to the letters J, K, and L and the number 4;
e) the digit 5 corresponds to the letters M, N and O and the number 5;
f) the digit 6 corresponds to the letters P, Q and R and the number 6;
g) the digit 7 corresponds to the letters S, T and U and the number 7;
h) the digit 8 corresponds to the letters V, W and X and the number 8; and
i) the digit 9 corresponds to the letters Y and Z and the number 9.

25. The numerical keypad of claim 24, wherein said keypad is provided on a remote control unit, a keyboard or a touchscreen.

26. A method of entering data into a data processing unit, comprising:
a) providing the numeric keypad of claim 24;
b) entering a number using said numeric keypad.

27. A method for linking an Internet site with a video feed, comprising:
a) providing an Internet user an option to link to a video feed, and
b) linking the user to a video feed upon selection of said option by said user.

28. The method of claim 27, wherein said user is a human.

29. The method of claim 27, wherein said option to link is displayed on a television set.

30. The method of claim 29, wherein said television set interfaces with the Internet with an interfacing hardware and optionally interfacing software.

31. The method of claim 30, wherein said interfacing hardware comprises a set-top device.

32. The method of claim 27, wherein said option comprises an advertisement.

33. The method of claim 27, wherein said option comprises a button.
